(19) United States
(12) Patent Application Publication
(10) Pub. No.: US 2016/0014588 A1
(43) Pub. Date: Jan. 14, 2016

(54) DATA COLLECTION AND MANAGEMENT SERVICE SYSTEM AND METHOD

(71) Applicant: SK PLANET CO., LTD., GYEONGGI-DO (KR)

(72) Inventors: CHUL YONG SHIN, SEOUL (KR); JAE HYUNG HUH, GYEONGGI-DO (KR)

(73) Assignee: SK PLANET CO., LTD., GYEONGGI-DO (KR)

(21) Appl. No.: 14/639,277

(22) Filed: Mar. 5, 2015

(30) Foreign Application Priority Data
Jul. 9, 2014 (KR) 10-2014-0086101

(51) Int. Cl. H04W 8/00; H04W 4/02; H04W 4/04; H04W 4/00

(52) U.S. Cl. CPC H04W 8/005; H04W 4/008; H04W 4/023; H04W 4/04; H04W 84/12

(57) ABSTRACT

Disclosed are a data collection and management service system and method, which can provide log data used when a customized service is provided, with relatively simplified processes and small resources by deriving log data on many unspecified terminals, such as the number of floating terminals in each collection region at each time zone and information on shops which each terminal visits by analyzing collected data actually collected through a scanning device installed in each region, a data collection and management device applied to the same, and an operation method of the data collection and management device.

### BACKGROUND OF THE INVENTION

1. Field of the Invention

The present disclosure relates to a data collection and management service system, and more particularly to a data collection and management service system and method which can extract and provide various pieces of log data on many unspecified moving terminals with relatively simplified processes and small resources based on the fact that most terminals support short-range wireless communication, a data collection and management device applied to the same, and an operation method of the data collection and management device.

2. Description of the Prior Art

Recently, small companies and private operators as well as large companies make various measures to attract many more customers, such as having limited time sales for customers who visit shops, issuing discount coupons which can be used during a predetermined period, and expanding business hours including an early opening time and a late closing time according to working hours of the customers.

As described above, such various measures to attract many customers can be different depending on a floating population around a shop at each time zone and a type of customer who frequently visits a shop or frequently moves around the shop.

Accordingly, an operator who manages the shop requires base data to understand the floating population around the shop at each time zone, the type of customers who frequently visits the shop or frequently moves around the shop, that is, base data necessary to attract customers. However, there is difficulty in acquiring such the base data.

Meanwhile, most current terminals have short range wireless communication functions such as Wi-Fi, Bluetooth, Near Field Communication (NFC) and the like to perform short range wireless communication with counterpart terminals.

The present disclosure provides a method of deriving various pieces of log data on many unspecified moving terminals, that is, base data required for attracting customers with relatively simplified processes and small resources based on the fact that most terminals support short range wireless communication.

### SUMMARY OF THE INVENTION

The present disclosure has been made to solve the above problems and an aspect of the present disclosure is to provide a data collection and management service system and method in which, when one or more scanning devices collect terminal identification information of a terminal approaching within a preset short range and provide collected data including the collected terminal identification information and at least one of a collection time point and a collection region, a data collection and management device stores the collected data received from the one or more scanning devices, derives at least one of the number of floating terminals in a particular collection region at each time zone and information on shops which a particular terminal visits by analyzing the stored collected data, and allows a customized service to use the number of floating terminals in the particular collection region at each time zone and the information on the shops which the particular terminal visits when interworking with the customized service, so as to derive and provide various pieces of log data on many unspecified terminals, that is, base data required for attracting customers with relatively simplified processes and small resources based on the fact that most terminals support short range wireless communication.

The present disclosure has been made to solve the above problems and another aspect of the present disclosure is to provide a data collection and management device, which receives collected data containing collected terminal identification information of a terminal approaching within a preset short range and at least one of a collection time point and a collection region from one or more scanning devices, stores the received collected data, derives at least one of the number of floating terminals in a particular collection region at each time zone and information on shops which a particular terminal visits by analyzing the stored collected data, and allows a customized service to use the number of floating terminals in the particular collection region at each time zone and the information on the shops which the particular terminal visits when interworking with the customized service, and an operation method of the data collection and management device, so as to derive and provide various pieces of log data on many unspecified terminals, that is, base data required for attracting customers with relatively simplified processes and small resources based on the fact that most terminals support short range wireless communication.

In accordance with an aspect of the present disclosure, a data collection and management device is provided. The data collection and management device includes: a data receiver configured to receive collected data containing collected terminal identification information and at least one of a collection time point and a collection region from one or more scanning devices collecting terminal identification information of a terminal approaching within a preset short range; and a data controller configured to store the received collected data and derive at least one of a number of floating terminals in a particular collection region at each time zone and information on a shop which a particular terminal visits by analyzing the stored collected data, so as to allow a customized service to use the number of floating terminals in the particular collection region at each time zone and the information on the shop which the particular terminal visits when interworking with the customized service.

The scanning device may extract and collect the terminal identification information of the terminal from a short-range wireless communication based message received from the terminal or acquire and collect the terminal identification information of the terminal from an access point transmitting/receiving the short-range wireless communication based message to/from the terminal, and the collection region may be a region in which the scanning device is installed or a region configured in the scanning device.

When there are collected data of which a collection time point interval is shorter than a preset threshold and of which collectin region is same during a preset collection term regarding the terminal identification information of the particular terminal, the data controller determines that the particular terminal visited a particular shop related to the same collection region and derives visited shop information of the particular terminal including information on the particular shop.

The data controller may change a collection period on which the scanning device in the particular collection region collects terminal identification information according to a collection period change request received from a shop terminal of a shop related to the particular collection region.

The customized service may include at least one of a service which recommends a shop opening time and a shop closing time to a shop terminal of a shop related to the particular collection region based on a time zone at which the number of floating terminals in the particular collection region rapidly increases and a time zone at which the number of floating terminals in the particular collection region rapidly decreases which are detected using the number of floating terminals in the particular collection region at each time zone, a service which recommends, with respect to a large shop including the particular region and one or more other collection regions, a product display layout for each of the particular collection region and the one or more other collection regions within the large shop based on ranking of the number of floating terminals in each of the particular collection region and the one or more other collection regions at each time zone, and a service which provides event information of a favorite shop to the particular terminal or allows, it the particular terminal visits the favorite shop, a shop terminal of the favorite shop to recognize the visit of the particular terminal based on the favorite shop of the particular terminal detected using visited shop information of, the particular terminal.

In accordance with another aspect of the present disclosure, a data collection and management service method is provided. The data collection and management service method includes: collecting terminal identification information of a terminal approaching within a preset short range and providing collected data containing the collected terminal identification information and at least one of a collection time point and a collection region by one or more scanning devices; storing the collected data received from the one or more scanning devices by a data collection and management device; and deriving at least one of a number of floating terminals in a particular collection region at each time zone and information on a shop which a particular terminal visits by analyzing the stored collected data and allowing a customized service to use the number of floating terminals in the particular collection region at each time zone and the information on the shop which the particular terminal visits when interworking with the customized service by the data collection and management device.

In accordance with another aspect of the present disclosure, an operation method of a data collection and management device is provided. The operation method includes: receiving collected data containing collected terminal identification information and at least one of a collection time and a collection region from one or more scanning devices collecting terminal identification information of a terminal approaching within a preset short range; storing the received collected data; and deriving at least one of a number of floating terminals in a particular collection region at each time zone and information on a shop which a particular terminal visits by analyzing the stored collected data, and allowing a customized service to use the number of floating terminals in the particular collection region at each time zone and the information on the shop which the particular terminal visits when interworking with the customized service.

The scanning device may extract and collect the terminal identification information of the terminal from a short-range wireless communication based message received from the terminal or acquire and collect the terminal identification information of the terminal from an access point transmitting/receiving the short-range wireless communication based message to/from the terminal, and the collection region may be a region in which the scanning device is installed or a region configured in the scanning device.

The deriving of the at least one of the number of floating terminals and the information on the shop which the particular terminal visits may include, when there are collected data of which a collection time point interval is shorter than a preset threshold and of which collectin region is same during a preset collection term regarding the terminal identification information of the particular terminal, determining that the particular terminal visited a particular shop related to the same collection region and deriving visited shop information of the particular terminal including information on the particular shop.

The operation method may further include changing a collection period on which the scanning device in the particular collection region collects terminal identification information according to a collection period change request received from a shop terminal of a shop related to the particular collection region.

According to a data collection and management service system and method, a data collection and management device applied to the same, and an operation method of the data collection and management device according to the present disclosure, based on the fact that most terminals support short range wireless communication, an effect of providing log data used when a customized service is provided, with relatively simplified processes and small resources can be achieved by installing, in respective regions, scanning devices which can collect terminal identification information of terminals based on short range wireless communication, storing the terminal identification information collected through the scanning devices, and deriving various pieces of log data on many unspecified moving terminals by analyzing the stored terminal identification information.

### BRIEF DESCRIPTION OF THE DRAWINGS

FIG. 1 illustrates an example of an installation of a scanning device according to an exemplary embodiment of the present disclosure;

FIG. 2 illustrates an example of a data collection and management service system according to an exemplary embodiment of the present disclosure;

FIG. 3 is a block diagram illustrating a configuration of a data collection and management device according to an exemplary embodiment of the present disclosure;

FIG. 4 illustrates an example of a control flow of a data collection and management service method according to an exemplary embodiment of the present disclosure; and

FIG. 5 is a flowchart illustrating a method of operating a data collection and management device according to an exemplary embodiment of the present disclosure.

### DETAILED DESCRIPTION OF THE EXEMPLARY EMBODIMENTS

Hereinafter, exemplary embodiments of the present disclosure will be described with reference to the accompanying drawings.

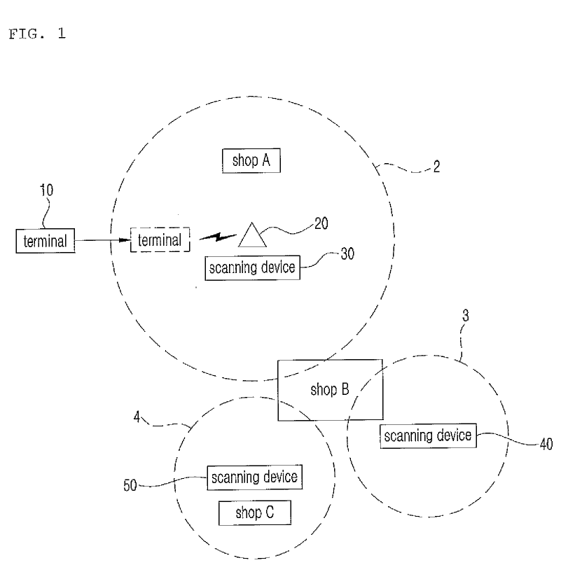

First, an example in which a scanning device is installed in each region according to an exemplary embodiment of the present disclosure will be described with reference to FIG. 1.

According to the present disclosure, various pieces of log data on many unspecified moving terminals are derived with relatively simplified processes and small resources based on the fact that most terminals support short-range wireless communication.

To this end, a description of the present disclosure will be made based on an assumption that the scanning device is installed in each region.

For example, as illustrated in FIG. 1, scanning devices 30, 40, 50 . . . may be installed in regions 2, 3, 4 . . . , each of which can be covered by one scanning device.

Further, as illustrated in FIG. 1, it is preferable that each of the regions 2, 3, 4 . . . is associated with at least one shop A, B, C . . . . For example, shop A may be located within the region 2 and thus associated with the region 2, shop C may be located within the region 4 and thus associated with the region 4, and shop B is a large shop, which may have gates in the respective regions 2, 3, and 4 and thus may be associated with the regions 2, 3, and 4.

At this time, the scanning device such as the scanning device 30 may be located close to an Access Point (AP) 20 which supports short-range communication within a region (for example, the region 2) in which the scanning device 30 is installed or the scanning device such as the scanning device 40 or 50 may be installed regardless of the AP.

The scanning devices 30, 40, 50 . . . may collect terminal identification information of a terminal approaching within a preset short range.

In a method in which the scanning device collects terminal identification information, the scanning device may collect terminal identification information by extracting the terminal identification information of the terminal from a short-range wireless communication based message or collect terminal identification information by acquiring the terminal identification information of the terminal from an AP which transmits/receives the short-range wireless communication based message.

Hereafter, a description will be made in detail based on a terminal 10 of FIG. 1. The terminal 10 is a terminal supporting short-range wireless communication.

At this time, the short-range wireless communication may be one of Wi-Fi and Bluetooth.

For example, in a case of Bluetooth, the scanning device, for example, the scanning device 40 or 50 may transmit/receive a short-range wireless communication based message (for example, an inquiry request message) by using BlueTooth (BT) classic in order to find a terminal approaching within a preset short range.

When the terminal 10 approaches the scanning device 40 within the preset short range as the terminal 10 enters the regions 3, the terminal 10 may receive the short-range wireless communication based message (for example, the inquiry request message) from the scanning device 40 and transmit a response thereto (for example, an inquiry response message).

At this time, the short-range wireless communication based message (for example, an inquiry request message) transmitted by the terminal 10 may contain terminal identification information of the terminal, that is, a Bluetooth mac address.

Then, the scanning device, for example, the scanning device 40 or 50 may extract the terminal identification information of the terminal, that is, the Bluetooth mac address from the response to the short-range wireless communication based message (for example, the inquiry request message) transmitted by the scanning device 40 or 50 on every preset period.

Meanwhile, in a case of Wi-Fi, when a short-range wireless communication function, that is, a Wi-Fi function is in an on state, the terminal 10 continuously searches for an AP, that is, a Wi-Fi AP by transmitting a short-range wireless communication based message (for example, a probe request message).

When the terminal 10 approaches the scanning device 20, that is, the Wi-Fi AP 20 within the preset short range as the terminal 10 enters the regions 2, the Wi-Fi AP 20 may receive the short-range wireless communication based message (for example, the probe request message) from the terminal 10, transmit a response thereto (for example, a probe response message), and then transmit/receive the short-range wireless communication based message so as to support the access of the terminal 10.

At this time, the short-range wireless communication based message (for example, the probe request message) transmitted by the terminal 10 may contain terminal identification information of the terminal 10, that is, a Wi-Fi mac address.

Then, the scanning device located (installed) close to the AP 20, that is, the Wi-Fi AP 20, for W example, the scanning device 30 may collect terminal identification information by acquiring the terminal identification information of the terminal accessing the Wi-Fi AP 20, that is, the Wi-Fi mac address from the Wi-Fi AP 20 on every preset collection period.

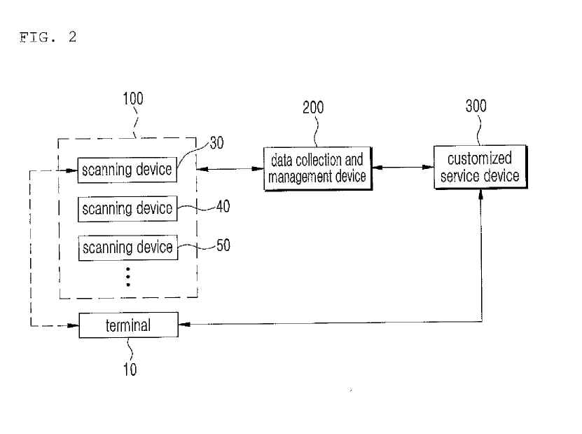

Hereinafter, a data collection and management service system according to the present disclosure including the scanning devices 30, 40, 50 . . . which are installed and operate as described above will be described with reference to FIG. 2.

As illustrated in FIG. 2, a data collection and management service system according to an exemplary embodiment of the present disclosure includes one or more scanning devices 100 and a data collection and management device 200.

The one or more scanning devices 100 include the scanning devices 30, 40, 50 . . . as described above with reference to FIG. 1.

The one or more scanning devices 100 collect terminal identification information of the terminal approaching within a preset short range and provide collected data containing the collected terminal identification information and at least one of a collection time point and a collection region.

In other words, the one or more scanning devices 100 may collect the terminal identification information of the terminal to generate collected data containing the collected terminal identification information and at least one of the collection time point and the collection region and provide the collected data to the data collection and management device 200.

At this time, it is preferable that the collection region is a region in which the scanning device having collected the terminal identification information is installed or a configuration region configured in the scanning device.

For example, it is assumed that the scanning device 30 collects terminal identification information of the terminal 10. In this case, the scanning device 30 may generate collected data containing the terminal identification information of the terminal 10 (for example, the WiFi mac address or the Bluetooth mac address), a collection time point (for example, date and time), and a collection region, that is, the region 2 in which the scanning device 30 is installed or the region 2 configured in the scanning device 30.

The one or more scanning devices 100 including the scanning devices 30, 40, 50 . . . repeatedly collect terminal identification information of the terminal on a preset collection period, generate collected data on each of pieces of collected terminal identification information, and provide the collected data to the data collection and management device 200. As a result, a lot of pieces of collected data received from the one or more scanning devices 100 are accumulated and stored in the data collection and management device 200.

The data collection and management device 200 stores the collected data received from the one or more scanning devices 100 and derives at least one of the number of floating terminals in a particular collection region at each time zone and information on a shop which a particular terminal visits by analyzing the stored collected data.

That is, the data collection and management device 200 derives log data on many unspecified terminals, such as the number of floating terminals in a particular collection region at each time zone and information on a shop which a particular terminal visits, according to the collected data collected/provided through the one or more scanning devices 100 based on the fact that most terminals support short-range wireless communication.

As described above, the data collection and management device 200 derives the log data on many unspecified terminals and uses the log data for a customized service of a customized service device 300 when interworking with the customized service, that is, the customized service device 300.

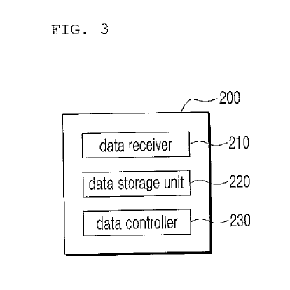

Hereinafter, a configuration of the data collection and management device according to the present disclosure will be described in detail with reference to FIG. 3.

As illustrated in FIG. 3, the data collection and management device 200 according to an exemplary embodiment of the present disclosure includes a data receiver 210 configured to receive collected data containing collected terminal identification information and at least one of a collection time point and a collection region from the one or more scanning devices 100 that collects terminal identification information of the terminal approaching within a preset short-range and a data controller 230 configured to store the received collected data and derive at least one of the number of floating terminals in a particular collection region at each time zone and information on a shop which a particular terminal visits by analyzing the stored collected data, so as to allow a customized service to use the number of floating terminals in the particular collection region at each time zone or the information on the shop which the particular terminal visits when interworking with the customized service.

Further, the data collection and management device 200 includes a data storage unit 220.

The data receiver 210 receives collected data containing collected terminal identification information and at least one of a collection time point and a collection region from the one or more scanning devices 100 that collects terminal identification information of the terminal approaching within a preset short-range.

As described above, the one or more scanning devices 100 repeatedly collects the terminal identification information of the terminal on every preset period, generates collected data on each of the collected terminal identification information, and provides the generated collected data to the data collection and management device 200.

The data receiver 210 corresponds to a configuration for receiving the collected data provided by the one or more scanning devices 100 as described above.

The data controller 230 stores the collected data received through the data receiver 210 in the data storage unit 220.

As a result, a lot of pieces of collected data received from the one or more scanning devices are accumulated and big data including the collected data is stored in the data storage unit 220.

Further, the data controller 230 may derive at least one of the number of floating terminals in a particular collection region at each time zone and information on a shop which a particular terminal visits by analyzing the collected data stored in the data storage unit 220 and allow a customized service to use the number of floating terminals in the particular collection region at each time zone and the information on the shop which the particular terminal visits when interworking with the customized service.

More specifically, the data controller 230 may derive the number of floating terminals in each collection region at each time zone by analyzing the collected data stored in the data storage unit 220 on every preset analysis period.

For example, when the scanning devices 30, 40, and 50 are installed in the regions 2, 3, and 4, respectively, as illustrated in FIG. 1, the data controller 230 may derive the number of floating terminals in each of the regions 2, 3, and 4 at each time zone by analyzing collected data stored in the data storage unit 220 on every preset analysis period.

At this time, deriving the number of floating terminals in the region at each time zone may refer to newly generating the number of floating terminals at each time zone if the region is a new region, and refer to updating the number of floating terminals in the corresponding region at each previous time zone if the region is the existing region.

Meanwhile, the data controller 230 may derive information on a shop which each terminal visits by analyzing the collected data stored in the data storage unit 220 on every preset analysis period.

At this time, when collected data of which a collection time point interval is shorter than a preset threshold period and which contains the same collection region continuously exists during a preset collection term in the collected data mapped with terminal identification information of a particular terminal, the data controller 230 may determine that the particular terminal visited the particular shop related to the same collection region and derive information on the shop which the particular terminal visited containing the information on the particular shop.

More specifically, the data controller 230 classifies the collected data stored in the data storage unit 220 based on each piece of terminal identification information on every preset analysis period.

Hereinafter, an example of a method of deriving information on a shop which the terminal 10 visits will be described by mentioning the collected data mapped to the terminal identification information of the terminal among the collected data classified based on each piece of terminal identification information.

The data controller 230 determines whether collected data, of which a collection time point interval is shorter than a preset threshold period (for example, 60 seconds) and which contains the same collection region, continuously exists during a preset collection term (for example, 5 minutes) in the collected data mapped with the terminal identification information of a particular terminal, for example, the terminal 10.

When the terminal 10 stays within the collection region 2 for five minutes or more based on an assumption that a collection period (for example, 50 seconds) shorter than a threshold period (for example, 60 seconds) is configured in the scanning device 30, collected data of the terminal 10, of which a collection time point interval is shorter than a threshold period (for example, 60 seconds) and which contains the same collection region 2, continuously existing during a collection term (for example, 5 minutes) may be provided to the data collection and management device 200 from the scanning device 30 unless the scanning device 30 malfunctions.

Accordingly, when collected data of which a collection time point interval is shorter than the threshold period (for example, 60 seconds) and which contains the same collection region 2 continuously exists during the collection term (for example, 5 minutes) in the collected data mapped with the terminal identification information of the terminal 10 stored in the data storage unit 220, it is considered that the terminal 10 stayed in the collection region 2 for 5 minutes or more and the terminal 10 visited a particular shop, that is, shop A related to the collection region 2.

However, when a collection period (for example, 50 seconds) shorter than the threshold period (for example, 60 seconds) is configured in the scanning device 30 but the terminal 10 merely passes through the collection region 2, collected data of the terminal 10, of which a collection time point interval is shorter than the threshold period (for example, 60 seconds) and which contains the same collection region 2, continuously existing during the collection term (for example, 5 minutes) is not provided to the data collection and management device 200 from the scanning device 30.

Further, when the collection period of the scanning device 30 is longer than the threshold period (for example, 60 seconds) even though the terminal 10 stayed in the collection region 2 for 5 minutes or more, whether the terminal 10 continuously stayed in the collection region 2 for 5 minutes or more or the terminal 10 passed in and out of a boundary of the collection region 2 cannot be recognized, it cannot be certain that the terminal 10 visited the particular shop, that is, shop A related to the collection region 2.

Accordingly, when it is determined that the collected data, of which a collection time point interval is shorter than the threshold period (for example, 60 seconds) and which contains the same collection region 2, continuously exists during the collection term (for example, 5 minutes) in the collected data mapped with the terminal identification information of the terminal 10, the data controller 230 may determine that the terminal 10 visited the particular shop, that is, shop A related to the same collection region 2.

As described above, when it is determined that the terminal 10 visited the particular shop, that is, shop A related to the same collection region 2, the data controller 230 may derive information on the shop which the terminal 10 visited including information on shop A (for example, a shop ID, a visiting time and the like).

That is, the information on the shop which the terminal 10 visited is information indicating when the terminal 10 visited the shop and what shop the terminal 10 visited.

At this time, deriving the information on the shop which the terminal visited may refer to, if the terminal is a new terminal, newly generating information on a shop which the terminal visited, and refer to, if the terminal is the existing terminal, updating information on a shop which the terminal previously visited.

Meanwhile, the data controller 230 may change a collection period on which the scanning device in a particular collection region collects terminal identification information according to a collection period change request received from a shop terminal of a shop related to the particular collection region.

For example, the collection region 2 will be described as an example. When a manager of shop A desires to more acutely distinguish between a terminal that merely passes through shop A and a terminal that visits shop A, the manager may make a request for changing a collection period configured in the scanning device 30 to be shorter by controlling a shop terminal (not shown) of shop A.

Of course, if it is not required to acutely distinguish between the terminal that merely passes through shop A and the terminal that visits shop A, it is preferable to configure the collection period to be somewhat long in consideration of power consumption of the scanning device 30.

Accordingly, when a collection period change request is received from a shop terminal (not shown) of shop A related to the collection region 2, the data controller 230 may change the collection period configured in the scanning device 30 in the collection region 2 according to the collection period change request from the shop terminal (not shown) of shop A.

Of course, a person (for example, the manager of shop A) may change the collection period configured in the scanning device 30 by directly controlling the scanning device 30.

As described above, the data collection and management device 230 may derive log data on many unspecified terminals, such as the number of floating terminals in each collection region at each time zone and information on a shop which each terminal visits, according to the collected data actually collected/provided through the one or more scanning devices 100 based on the fact that most terminals support short-range wireless communication.

Then, the data collection and management device 230 derives the log data on many unspecified terminals as described above to allow a customized service of the customized service device 300 to use the log data (the number of floating terminals in each collection region at each time zone and the information on the shops which each terminal visits) when interworking with the customized service, that is, the customized service device 300 providing the customized service.

Hereinafter, the customized service using the log data (the number of floating terminals in each collection region at each time zone and the information on the shops which each terminal visits) of the data collection and management device 200 according to the present disclosure will be described.

For example, the customized service using the log data according to the present disclosure may be a service that recommends a shop opening time and a shop closing time to a shop terminal of a shop related to a particular collection region based on a time zone at which the number of floating terminals in the particular collection region rapidly increases and a time zone at which the number of floating terminals in the particular collection region rapidly decreases which are detected using the number of floating terminals in the particular collection region at each time zone.

For example, among the collection regions, the collection region 2 will be described in more detail as an example.

For example, when the customized service device 300 receives a request for recommending the collection region 2 from a terminal accessing the customized service or when a recommendation period of the collection region 2 arrives, the customized service device 300 may identify the number of floating terminals in the collection region 2 at each time zone by interworking with the data collection and management device 200 and grasp a time zone at which the number of floating terminals in the collection region 2 rapidly increases and a time zone at which the number of floating terminals in the collection region 2 rapidly decreases by using the number of floating terminals in the identified collection region 2 at each time zone.

Then, the customized service device 300 may recommend a shop opening time and a shop closing time to a shop terminal (not shown) of shop A related to the collection region 2 based on the grasped time zone at which the number of floating terminals in the collection region 2 rapidly increases and the grasped time zone at which the number of floating terminals in the collection region 2 rapidly decreases, so as to provide the customized service.

At this time, the recommended shop opening time is associated with the time zone at which the number of floating terminals in the collection region 2 rapidly increases and the recommended shop closing time is associated with the time zone at which the number of floating terminals in the collection region 2 rapidly decreases.

Of course, the customized service device 300 may provide the shop opening time and the shop closing time to allow the terminal accessing the customized service to read according to a reading request from the terminal.

Meanwhile, the customized service using the log data according to the present disclosure may be a service which, with respect to a large shop related to a particular collection region and one or more other collection regions, recommends product layout in the large shop based on each position corresponding to the particular collection region and the one or more other collection regions to a shop terminal of the large shop based on a ranking of the number of floating terminals in each of the particular collection region and the one or more other collection regions at each time zone which is detected using the number of floating terminals in each of the particular collection region and the one or more other collection regions at each time zone.

For example, a large shop, that is, shop B illustrated in FIG. 1 will be described in more detail as an example.

For example, as illustrated in FIG. 1, shop B may be a large shop having gates in two or more collection regions 2, 3, and 4.

With respect to shop B, a particular collection region related to a large shop refers to one of two or more collection regions 2, 3, and 4, and one or more other collection regions refer to the remainder except for the particular collection region among the two or more collection regions 2, 3, and 4.

As described above, with respect to a large shop, that is, shop B, when the customized service device 300 receives a request for recommending shop B from a terminal accessing the customized service or when a recommendation period of shop B arrives, the customized service device 300 may identity the number of floating terminals in each of the collection regions 2, 3, and 4 by interworking with the data collection and management device 200 and grasp a ranking of the number of floating terminals in each of the collection regions 2, 3, and 4 at each time zone by using the number of floating terminals in each of the collection regions 2, 3, and 4.

That is, the customized service device 300 determines the collection region having the largest number of floating terminals as a first rank among the collection regions 2, 3, and 4, the collection region having the next largest number of floating terminals as a second rank, and the collection region having the smallest number of floating terminals as a last rank, so as to grasp a ranking of the number of floating terminals in each of the collection regions 2, 3, and 4 at each time zone.

Accordingly, the customized service device 300 may recommend the product layout based on each position within shop B corresponding to each of the particular collection region and one or more other collection regions, that is, each of the two or more collection regions 2, 3, and 4 to the shop terminal of the large shop, that is, shop B based on the grasped ranking of the number of floating terminals in each of the collection regions 2, 3, and 4 at each time zone, so as to provide the customized service.

At this time, each position within shop B corresponding to each of the two or more collection regions 2, 3, and 4 may refer to each gate of shop B corresponding to each of the collection regions 2, 3, and 4.

Accordingly, the ranking of the number of floating terminals in each of the collection regions 2, 3, and 4 at each time zone finally means a ranking of each gate of shop B based on a floating population (=the number of floating terminals) at each time zone.

Accordingly, the customized service device 300 may recommend the product layout suggested in such a manner that the larger number of products are displayed in the layout close to the gate having a higher rank of the number of floating terminals at each time zone and the smaller number of products are displayed in the layout having a lower rank of the number of floating terminals at each time zone.

Of course, the customized service device 300 may provide the product layout to allow the terminal accessing the customized service to read according to a reading request from the terminal.

Meanwhile, the customized service using the log data according to the present disclosure may be a service that provides event information of a favorite shop to a particular terminal or allows, if the particular terminal visits the favorite shop, a shop terminal of the favorite shop to recognize the visit of the particular terminal based on the favorite shop of the particular terminal detected using information on shops which the particular terminal visits.

For example, as described above, the following description will be made in more detail by mentioning the terminal 10.

When it is assumed that shop A and shop B are derived as information on shops which the terminal 10 visits by the data collection and management device 200, particularly, the data controller 230, if a recommendation period of at least one of shop A and shop B arrives, the customized service device 300 identifies the terminal included within visited shop information of the corresponding shop through an interworking with the data collection and management device 200 with respect to both shop A and shop B.

Accordingly, the customized service device 300 identifies the terminal 10 and grasps the favorite shop of the terminal 10 by using the visited shop information of the terminal 10. For example, the customized service device 300 may grasp a shop which the terminal 10 visits by the particular number of times (for example, 20 times) or more as the favorite shop, and shop A will be described hereinafter as the favorite shop of the terminal 10 for the convenience of the description.

Accordingly, based on the favorite shop of the terminal 10, that is, shop A, the customized service device 300 may provide the customized service by providing event information (for example, discount information, promotion information, coupons and the like) registered in shop A to the terminal 10 or allowing, if the terminal 10 visits shop A, a shop terminal (not shown) of shop A to immediately recognize the visit of the terminal 10.

At this time, in a method of providing the event information to the terminal 10, the customized service device 300 may provide the event information to the terminal 10 in a push manner through an interworking with a push service or the customized service device 300 may map the event information and terminal identification information of the terminal 10, pre-transmit/store the mapped event information and terminal identification information to the scanning device 30 of the collection region 2 related to shop A, and provide the event information to the terminal 10 through short-range wireless communication immediately at a time point when the scanning device 30 initially collects the terminal identification information of the terminal 10.

Meanwhile, in a method of allowing the shop terminal (not shown) of shop A to recognize the visit of the terminal 10 when the terminal 10 visits shop A, the customized service device 300 may pre-transmit/store the terminal identification information of the terminal 10 to the scanning device 30 and directly provide a notification message to the shop terminal (not shown) of shop A at a time point when the scanning device 30 initially collects the terminal identification information of the terminal 10 or provide the notification message to the shop terminal (not shown) of shop A through the customized service device 300, so as to allow the shop terminal (not shown) of shop A to recognize the visit of the terminal 10.

As described above, the data collection and management service system and the data collection and management device applied to the same according to the present disclosure may derive log data on many unspecified terminals, such as the number of floating terminals in each collection region at each time zone and information on shops which each terminal visits by analyzing collected data actually collected through the scanning device installed in each region, thereby creating an effect which can provide log data used when the customized service is provided, with relatively simplified processes and small resources.

Meanwhile, although the data collection and management device 200 and the customized service device 300 that provides the customized service according to the present disclosure have been described as separated independent devices, it is only an embodiment.

That is, the data collection and management device 200 according to the present disclosure can directly provide the above described customized service.

Further, as described above, since the log data is derived based on terminal identification information of the terminal (a Bluetooth mac address and a WiFi mac address), the log data according to the present disclosure cannot reflect personal characteristics (age, sex, tendency, hobby and the like) of a user who uses the terminal.

However, when the user joins the service provided by the data collection and management device 200 according to the present disclosure, if terminal identification information of the terminal belonging to the joined user is terminal identification information existing in pre-stored/derived log data from the data collection and management device 200, various service models which can provide a more personalized customized service can be created by additionally mapping and managing the personal information (for example, age, sex, tendency, hobby and the like) input by the user when the user joins the service and the terminal identification information.

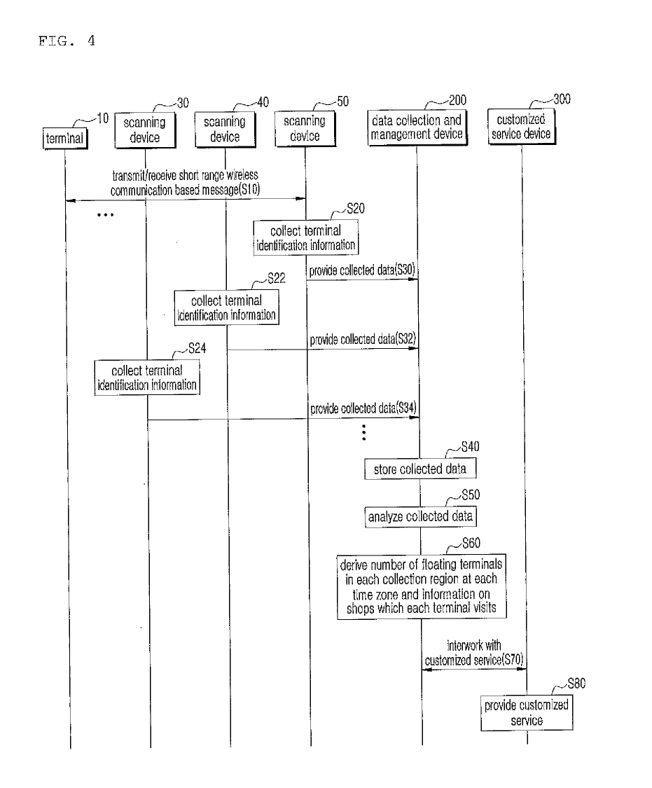

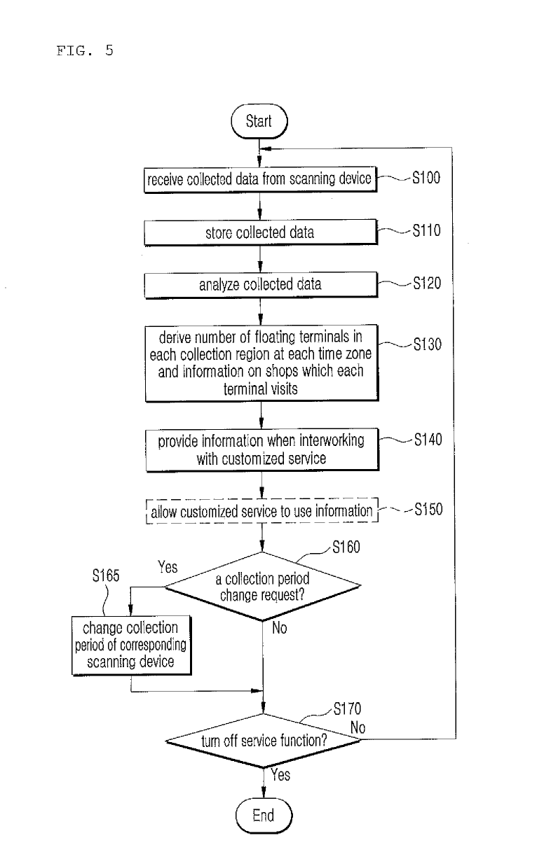

Hereinafter, a data collection and management service method according to an exemplary embodiment of the present disclosure will be described with reference to FIGS. 4 and 5. For the convenience of the description, the reference numerals of FIGS. 1 to 3 will be used.

First, a data collection and management service method according to an exemplary embodiment of the present disclosure will be described with reference to FIG. 4.

In the present disclosure, the scanning devices 30, 40, 50 . . . are basically installed in regions, respectively, as illustrated in FIG. 1.

The scanning devices 30, 40, 50 . . . may collect terminal identification information of a terminal approaching within a preset short range in steps S20, S22, and S24.

The following description will be made with reference to FIG. 1 based on the scanning device 40 among the scanning devices 30, 40, 50 . . . and Bluetooth as short-range wireless communication. When the terminal 10 approaches the scanning device 40 within a preset short range as the terminal 10 enters the region 3, the terminal 10 may receive a short-range wireless communication based message (for example, an inquiry request message) from the scanning device 40 and transmits a response (for example, an inquiry response message) in step S10.

At this time, the short-range wireless communication based message (for example, the inquiry request message) transmitted by the terminal 10 may contain terminal identification information of the terminal 10, that is, a Bluetooth mac address.

Then, the scanning device, for example, the scanning device 40 may extract the terminal identification information of the terminal, that is, the Bluetooth mac address from the response to the short-range wireless communication based message (for example, the inquiry request message) on every preset period.

The scanning devices 30, 40, 50 . . . provide the terminal identification information collected in steps S20, S22, and S24 and collected data containing at least one of a collection time point and a collection region in steps S30, S32, and S34.

In other words, the scanning devices 30, 40, 50 . . . may collect the terminal identification information of the terminal on every preset collection period, generate the collected data containing the collected terminal identification information and at least one of the collection time point and the collection region, and provide the collected data to the data collection and management device 200 in steps S30, S32, and S34.

Then, the data collection and management device 200 stores a lot of accumulated collected data received from the one or more scanning devices 30, 40, 50 . . . in step S40.

The data collection and management device 200 stores the collected data received from the scanning devices 30, 40, 50 . . . and derives at least one of the number of floating terminals in a particular collection region at each time zone and information on shops which a particular terminal visits by analyzing the stored collected data in steps S50 and S60.

That is, the data collection and management device 200 derives log data on many unspecified terminals, such as the number of floating terminals in a particular collection region at each time zone and information on a shop which a particular terminal visits, according to the collected data collected/provided through the one or more scanning devices 30, 40, 50 . . . based on the fact that most terminals support short-range wireless communication.

Then, the data collection and management device 200 derives the log data on many unspecified terminals as described above and allows the customized service of the customized service device 300 to use the log data when interworking with the customized service, that is, the customized service device 300 in step S70.

That is, in step S80, the customized service device 300 may provide the customized service using the log data on many unspecified terminals through the interworking with the data collection and management device 200 in step S70.

Hereinafter a method operating the data collection and management device according to an exemplary embodiment of the present disclosure will be described with reference to FIG. 5.

In the method of operating the data collection and management device 200 according to the present disclosure, pieces of collected data provided from the scanning devices 30, 40, 50 . . . as described above are received in step S100.

Then, in the method of operating the data collection and management device 200 according to the present disclosure, the collected data from the scanning devices 30, 40, 50 . . . is stored in step S110.

As a result, in the method of operating the data collection and management device 200 according to the present disclosure, a lot of pieces of collected data received from the scanning devices 30, 40, 50 . . . are accumulated and big data including the collected data is stored.

In the method of operating the data collection and management device 200 according to the present disclosure, at least one of the number of floating terminals in each collection region at each time zone and information on shops which each terminal visits is derived in step S130 by analyzing pre-stored collected data on a preset analysis period in step S120.

More specifically, in the method of operating the data collection and management device 200 according to the present disclosure, the number of floating terminals in each collection region at each time zone may be derived by analyzing the pre-stored collected data on the preset analysis period.

For example, when the scanning devices 30, 40, and 50 are installed in the regions 2, 3, and 4, respectively, as illustrated in FIG. 1, the data collection and management device 200 may derive the number of floating terminals in each of the regions, that is, the regions 2, 3, and 4 at each time zone through the analysis (for example, a data mining algorithm) of the pre-stored collected data on the preset analysis period.

Meanwhile, in the method of operating the data collection and management device 200 according to the present disclosure, the information on shops which each terminal visits may be derived by analyzing the pre-stored collected data on the preset analysis period.

At this time, in the method of operating the data collection and management device 200 according to the present disclosure, when collected data, of which a collection time point interval is shorter than a preset threshold period and which contains the same collection region, continuously exists during a preset collection term in the collected data mapped with terminal identification information of a particular terminal, the data collection and management 200 may determine that the particular terminal visited the particular shop related to the same collection region and derive information on the shop which the particular terminal visited containing the information on the particular shop.

More specifically, in the method of operating the data collection and management device 200 according to the present disclosure, the pre-stored collected data is classified based on each piece of terminal identification information on the preset analysis period.

Hereinafter, an example of a method of deriving information on a shop which the terminal 10 visits will be described by mentioning the collected data mapped to the terminal identification information of the terminal 10 among the collected data classified based on each piece of terminal identification information.

In the method of operating the data collection and management device 200 according to the present disclosure, the data collection and management device 200 determines whether collected data, of which a collection time point interval is shorter than a preset threshold period (for example, 60 seconds) and which contains the same collection region, continuously exists during a preset collection term (for example, 5 minutes) in the collected data mapped with the terminal identification information of a particular terminal, for example, the terminal 10.

When the terminal 10 stays within the collection region 2 for five minutes or more based on an assumption that a collection period (for example, 50 seconds) shorter than a threshold period (for example, 60 seconds) is configured in the scanning device 30, collected data of the terminal 10, of which a collection time point interval is shorter than a threshold period (for example, 60 seconds) and which contains the same collection region 2, continuously existing during a collection term (for example, 5 minutes) may be provided to the data collection and management device 200 from the scanning device 30 unless the scanning device 30 malfunctions.

Accordingly, when collected data, of which a collection time point interval is shorter than the threshold period (for example, 60 seconds) and which contains the same collection region 2, continuously exists during the collection term (for example, 5 minutes) in the collected data mapped with the terminal identification information of the terminal 10 stored in the data storage unit 220, it is considered that the terminal 10 stayed in the collection region 2 for 5 minutes or more and the terminal 10 visited a particular shop, that is, shop A related to the collection region 2.

Accordingly, in the method of operating the data collection and management device 200 according to the present disclosure, when it is determined that the collected data, of which a collection time point interval is shorter than the threshold period (for example, 60 seconds) and which contains the same collection region 2, continuously exists during the collection term (for example, 5 minutes) in the collected data mapped with the terminal identification information of the terminal 10, the data collection and management device 200 may determine that the terminal 10 visited the particular shop, that is, shop A related to the same collection region 2.

As described above, in the method of operating the data collection and management device 200 according to the present disclosure, when it is determined that the terminal 10 visited the particular shop, that is, shop A related to the same collection region 2, the data collection and management device 200 may derive information on the shop which the terminal 10 visited including information on shop A (for example, a shop ID, a visiting time and the like).

As described above, in the method of operating the data collection and management device 200 according to the present disclosure, the data collection and management device 200 may derive log data on many unspecified terminals, such as the number of floating terminals in each collection region at each time zone and information on shops which each terminal visits, according to the collected data actually collected/provided through the one or more scanning devices 100 based on the fact that most terminals support short-range wireless communication.

Then, in the method of operating the data collection and management device 200 according to the present disclosure, the data collection and management device 200 derives the log data on many unspecified terminals to allow the customized service of the customized service device 300 to use the log data (the number of floating terminals in each collection region at each time zone and the information on the shops which each terminal visits) when interworking with the customized service, that is, the customized service device 300 providing the customized service in steps S140 and 150.

Since the customized service using the log data (the number of floating terminals in each collection region at each time zone and the information on the shops which each terminal visits) of the data collection and management device 200 according to the present disclosure has been described in detail with reference to FIG. 3, a description thereof will be omitted herein.

Meanwhile, in the method of operating the data collection and management device 200 according to the present disclosure, the data controller 200 may change a collection period on which the scanning device in a particular collection region collects terminal identification information according to a collection period change request received from a shop terminal of a shop related to the particular collection region.

For example, the collection region 2 will be described as an example. When a manager of shop A desires to more acutely distinguish between a terminal that merely passes through shop A and a terminal that visits shop A, the manager may make a request for changing a collection period configured in the scanning device 30 to be shorter by controlling a shop terminal (not shown) of shop A.

Of course, if it is not required to acutely distinguish between the terminal that merely passes through shop A and the terminal that visits shop A, it is preferable to configure the collection period to be somewhat long in consideration of power consumption of the scanning device 30.

Accordingly, when a collection period change request is received from a shop terminal (not shown) of shop A related to the collection region 2 in step S160-Yes, the data collection and management device 200 may change the collection period configured in the scanning device 30 in the collection region 2 according to the collection period change request from the shot terminal (not shown) of shop A in step S165 in the method of operating the data collection and management device 200 according to the present disclosure.

At this time, although steps S160 and S165 are shown to follow step S150 in FIG. 5, it is only an example for the convenience of the description. In the method of operating the data collection and management device 200 according to the present disclosure, the data collection and management device 200 may change the collection period of the scanning device according to the received collection period change request by always identifying whether the collection period change request is received in steps S160 and S165 regardless of steps S100 to S150 unless a service function is turned off in the data collection and management device 200 according to the present disclosure in step S170—No.

As described above, the data collection and management service system and the data collection and management device applied to the same according to the present disclosure may derive log data on many unspecified terminals, such as the number of floating terminals in each collection region at each time zone and information on shops which each terminal visits by analyzing collected data actually collected through the scanning device installed in each region, thereby creating an effect which can provide log data used when the customized service is provided, with relatively simplified processes and small resources.

The data collection and management service method and the method of operating the data collection and management device according to an embodiment of the present disclosure may be implemented in the form of program commands executable through various computer means and recorded in a computer readable medium. The computer readable medium may include a program command, a data file, a data structure, and the like independently or in combination. The program command recorded in the medium may be things specially designed and configured for the present invention, or things that are well known to and can be used by those skilled in the computer software related art. Examples of the computer-readable recording medium include magnetic media such as hard disks, floppy disks and magnetic tapes, optical media such as a Compact Disc Read-Only Memory (CD-ROM) and a Digital Versatile Disc (DVD), magneto-optical media such as floppy disks, and hardware devices such as a Read-Only Memory (ROM), a Random Access Memory (RAM) and a flash memory, which are specially configured to store and perform program instructions. Examples of the program command include a machine language code generated by a compiler and a high-level language code executable by a computer through an interpreter and the like. The hardware devices may be configured to operate as one or more software modules to perform the operations of the present invention, and vice versa.

Although the present disclosure has been described in detail with reference to exemplary embodiments, the present disclosure is not limited thereto and it is apparent to those skilled in the art that various modifications and changes can be made thereto without departing from the scope of the present disclosure.

### INDUSTRIAL APPLICABILITY

According to a data collection and management service system and method, a data collection and management device applied to the same, and an operation method of the data collection and management device according to the present disclosure, the present disclosure is highly applicable to the industries since, as the present disclosure passes the limit of the conventional technologies, related technologies of the present disclosure can be used and also the device to which the present disclosure is applied has a high probability of entering into the market and being sold, and thus the present disclosure can be obviously implemented in reality in that various pieces of log data on many unspecified moving terminals can be derived and provided with relatively simplified processes and small resources based on the fact that most terminals support short range wireless communication.

What is claimed is:

1. A data collection and management device comprising:
a data receiver configured to receive collected data containing collected terminal identification information and at least one of a collection time point and a collection region from one or more scanning devices collecting terminal identification information of a terminal approaching within a preset short range; and
a data controller configured to store the received collected data and derive at least one of a number of floating terminals in a particular collection region at each time zone and information on a shop which a particular terminal visits by analyzing the stored collected data, so as to allow a customized service to use the number of floating terminals in the particular collection region at each time zone and the information on the shop which the particular terminal visits when interworking with the customized service.

2. The data collection and management device of claim 1, wherein the scanning device extracts and collects the terminal identification information of the terminal from a short-range wireless communication based message received from the terminal or acquires and collects the terminal identification information of the terminal from an access point transmitting/receiving the short-range wireless communication based message to/from the terminal, and the collection region is a region in which the scanning device is installed or a region configured in the scanning device.

3. The data collection and management device of claim 1, wherein, when there are collected data of which a collection time point interval is shorter than a preset threshold and of which collectin region is same during a preset collection term regarding the terminal identification information of the particular terminal, the data controller determines that the particular terminal visited a particular shop related to the same collection region and derives visited shop information of the particular terminal including information on the particular shop.

4. The data collection and management device of claim 1, wherein the data controller changes a collection period on which the scanning device in the particular collection region collects terminal identification information according to a collection period change request received from a shop terminal related to the particular collection region.

5. The data collection and management device of claim 1, wherein the customized service includes at least one of a service which recommends a shop opening time and a shop closing time to a shop terminal of a shop related to the particular collection region based on a time zone at which the number of floating terminals in the particular collection region rapidly increases and a time zone at which the number of floating terminals in the particular collection region rapidly decreases which are detected using the number of floating terminals in the particular collection region at each time zone,
a service which recommends, with respect to a large shop including the particular region and one or more other collection regions, a product display layout for each of the particular collection region and the one or more other collection regions within the large shop based on ranking of the number of floating terminals in each of the particular collection region and the one or more other collection regions at each time zone, and
a service which provides event information of a favorite shop to the particular terminal or allows, if the particular terminal visits the favorite shop, a shop terminal of the favorite shop to recognize the visit of the particular terminal based on the favorite shop of the particular terminal detected using visited shop information of the particular terminal.

6. A data collection and management service method comprising:
collecting terminal identification information of a terminal approaching within a preset short range and providing collected data containing the collected terminal identification information and at least one of a collection time point and a collection region by one or more scanning devices;
storing the collected data received from the one or more scanning devices by a data collection and management device; and
deriving at least one of a number of floating terminals in a particular collection region at each time zone and information on a shop which a particular terminal visits by analyzing the stored collected data and allowing a customized service to use the number of floating terminals in the particular collection region at each time zone and the information on the shop which the particular terminal visits when interworking with the customized service by the data collection and management device.

7. An operation method of a data collection and management device, the operation method comprising:
receiving collected data containing collected terminal identification information and at least one of a collection time and a collection region from one or more scanning devices collecting terminal identification information of a terminal approaching within a preset short range;
storing the received collected data; and
deriving at least one of a number of floating terminals in a particular collection region at each time zone and information on a shop which a particular terminal visits by analyzing the stored collected data, and allowing a customized service to use the number of floating terminals in the particular collection region at each time zone and the information on the shop which the particular terminal visits when interworking with the customized service.

8. The operation method of claim 7, wherein the scanning device extracts and collects the terminal identification information of the terminal from a short-range wireless communication based message received from the terminal or acquires and collects the terminal identification information of the terminal from an access point transmitting/receiving the short-range wireless communication based message to/from the terminal, and the collection region is a region in which the scanning device is installed or a region configured in the scanning device.

9. The operation method of claim 7, wherein the deriving of the at least one of the number of floating terminals and the information on the shop which the particular terminal visits comprises, when there are collected data of which a collection time point interval is shorter than a preset threshold and of which collectin region is same during a preset collection term regarding the terminal identification information of the particular terminal, determining that the particular terminal visited a particular shop related to the same collection region and deriving visited shop information of the particular terminal including information on the particular shop.

10. The operation method of claim 9, further comprising changing a collection period on which the scanning device in the particular collection region collects terminal identification information according to a collection period change request received from a shop terminal related to the particular collection region.
